(19) United States
(12) Patent Application Publication
(10) Pub. No.: US 2005/0273381 A1
(43) Pub. Date: Dec. 8, 2005

(54) System and method for monitoring employee productivity, attendance and safety

(76) Inventor: Stephen Michael Thomas, Wheeling, WV (US)

Correspondence Address: Pepper Hamilton LLP;One Mellon Center, 50th Floor, 500 Grant Street, Pittsburgh, PA, 15219, US

(21) Appl. No.: 10/859,012

(22) Filed: Jun. 2, 2004

(51) Int. Cl. G06F 17/60

(52) U.S. Cl. 705/11

(57) ABSTRACT

An employee productivity, attendance and safety system maintains safety identifiers, and occupation identifiers for employees. The system may track training sessions completed and/or required, attendance and productivity.

### TECHNICAL FIELD

The present invention generally relates to methods and systems for employee record keeping. More particularly, the present invention relates to methods and system for monitoring, tracking, and/or reporting information relating to employee productivity, attendance and/or safety.

### BACKGROUND

In the past, many companies have spent a considerable amount of time and effort developing and implementing systems to document, assess and provide reports involving employee-related data. The employee-related data may include items like attendance data, records of training provided, evaluation and other performance-related communications, productivity information, salary and promotion history information, and other information. With limited exceptions, most of this data is documented and recorded by hand and requires human analysis in order to provide meaningful information for the employer. Methods of collecting and reporting some of this data, such as timekeeping information, has been automated in many settings. However, the automated systems limited to certain types of data and generally do not interface with each other. Therefore, while systems may be available to automatically track employee attendance data, no means exist to use this data with other data to provide more reliable productivity, training, safety or other information.

If methods and systems were available to automate the collection, analysis, and delivery of safety-related communications for the employer, many benefits would result. For example, uniform responses to safety-related incidents could be ensured, and resolution and accountability of training related incidents would be improved. If safety information were tied to productivity information and/or attendance data in an automated method and system, and the additional benefits could result. For example, human resource administrators and supervisors who implement employee incentive programs could access reliable information relating to employee performance at the touch of a button or screen. In addition, employers could more accurately monitor safety training and other training, thus allowing them to ensure that employees who may have been absent during critical training sessions receive appropriate training when they are present on a job.

The present invention is directed to addressing one or more of the issues described above.

### BRIEF DESCRIPTION OF THE DRAWINGS

FIG. 1 is a flow diagram showing steps that may be performed in accordance with a preferred embodiment of the presented inventive method.

FIG. 2 illustrates an exemplary computer screen that allows a user to select a safety-related report for individual employees or for multiple employees who are supervised by a particular supervisor.

FIG. 3 illustrates an exemplary computer screen that allows a user, preferably a supervisor, to input safety-related contact information for individual employees.

FIG. 4 illustrates an exemplary screen that allows a user, preferably a supervisor, to record safety incident information relating to individual employees.

FIG. 5 illustrates an exemplary screen that allows a user, preferably a supervisor, to record training sessions that have been completed by individual employees.

FIG. 6 is a block diagram illustrating exemplary components of a preferred embodiment of the present inventive system.

FIG. 7 is a block diagram illustrating preferred elements of a computing apparatus or system that may be used with the present invention.

### SUMMARY

Before the present methods, systems and materials are described, it is to be understood that this invention is not limited to the particular methodologies, systems and materials described, as these may vary. It is also to be understood that the terminology used in the description is for the purpose of describing the particular versions or embodiments only, and is not intended to limit the scope of the present invention which will be limited only by the appended claims.

It must also be noted that as used herein and in the appended claims, the singular forms “a,” “an,” and “the” include plural references unless the context clearly dictates otherwise. Unless defined otherwise, all technical and scientific terms used herein have the same meanings as commonly understood by one of ordinary skill in the art. Although any methods, materials, and devices similar or equivalent to those described herein can be used in the practice or testing of embodiments of the present invention, the preferred methods, materials, and devices are now described. All publications mentioned herein are incorporated by reference. Nothing herein is to be construed as an admission that the invention is not entitled to antedate such disclosure by virtue of prior invention.

In accordance with a preferred embodiment of the present invention, a method of organizing employee safety information includes the step of maintaining a set of safety identifiers in a computer readable medium. Each safety identifier relates to at least one safety-related job procedure and at least one occupation identifier. The method also includes the steps of obtaining an employee identifier that corresponds to an employee, linking the employee identifier with an occupation identifier, and identifying the safety identifiers that correspond to the linked occupation identifier to determine which safety identifiers may apply to the employee. The method also includes reporting information relating to one or more of the safety identifiers to a user.

Optionally, the method may also include the step of accessing a set of completed training session identifiers from a memory. Each completed training session identifier may represent the training session that the employee has completed or another safety-related communication that the employee has received, whether orally or in writing. The method may also include the step of determining whether any of the safety identifiers have corresponding training sessions that are not represented in the set of completed training identifiers. As an additional option, in the reporting step, the information recorded may include information about safety identifiers that do not have corresponding training sessions in the set of completed training session identifiers. Thus, a user may be informed of the job procedures for which the employee requires additional training in this option.

Optionally, if a job procedure and/or a training session has been modified, the reporting step may inform the user of the modifications in order to alert the user that the employee requires additional training. In addition, the method may include receiving time and attendance data for the employee to confirm whether any training session occurred a time when the employee was absent. If an employee was absent during a training session, the system may generate an alert indicating that the employee has missed a training session and therefore must receive training.

Optionally, one or more passwords or other identification codes must be entered before a user can receive, modify, or view some or all data in the system. Also optionally, the system may provide reporting information for individual employees, all employees that report to a particular supervisor, or as a collective report with data involving all employees in a particular group or organization.

The method may be implemented by a computing system having a memory on a processor. The memory may include any computer-readable medium that stores computer program instructions that instruct the employer to perform some or all of the steps described above. The method may also be implemented by an employee timekeeping system.

Optionally, the system may include a productivity input module that accepts measurements of productivity from a production environment, a time and attendance input module, a reporting module and/or a security module. The system may also include a safety training module and/or an alert module.

### DETAILED DESCRIPTION

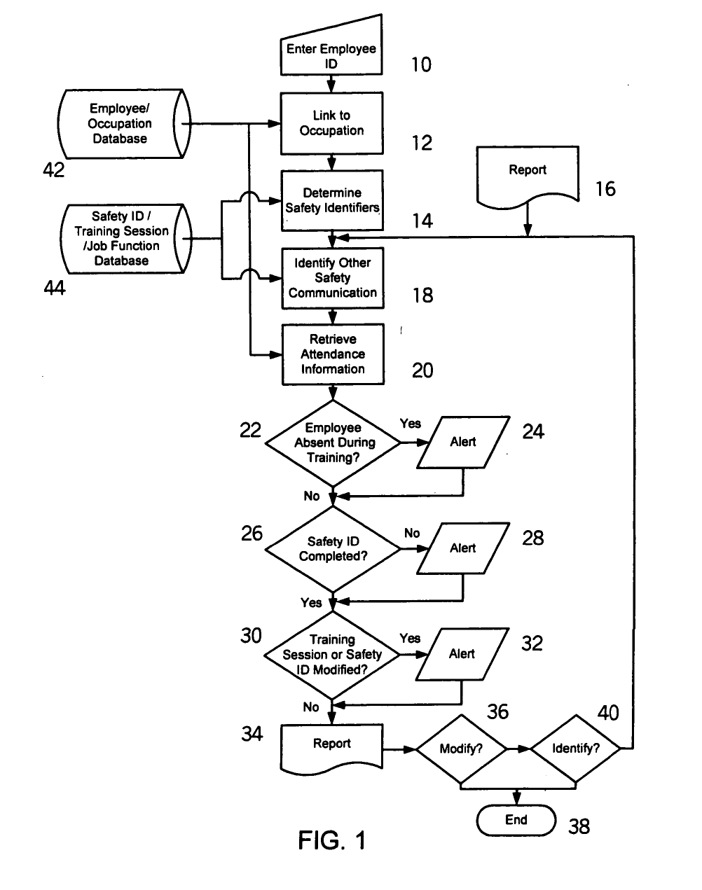

The present invention provides a method and/or system for monitoring and tracking employee productivity, attendance and/or safety-related information. FIG. 1 illustrates exemplary steps that may be followed in accordance with a preferred embodiment of the method of the present invention. Referring to FIG. 1, a user enters 10 an employee identification code that corresponds to an individual employee that is employed at a location. The employee code may be the employee's name, social security number, identification number, or other alphanumeric identifier. The code is preferably linked to an occupation identifier so that the system may know the occupation or position held by the employee based on the employee code. Optionally, steps 10 and 12 may be reversed, such that the user may enter 12 an occupation code and retrieve a list of all employees that correspond to the occupation code (e.g., all employees that hold a particular title or perform a particular function). This allows the user to use the system with reference to either an individual employee or a group of employees that are somehow related. Optionally, the employee identification entered in step 10 may be a supervisory employee, in which case all employees and/or occupations that report to the supervisor may be presented to the user.

Once one or more employees or occupations are identified, the system accesses a database of safety identifiers and identifying 14 one or more safety identifiers that relate to the employee. The safety identifier relates to at least one safety-related job procedure or other action for the employee. For example, the identifier may include a set of safe working procedures for performing a particular task. The safety identifier may also include tasks that must be completed in order to receive credit for completing a job function in a safe manner. Optionally, the system may generate 16 a report identifying one or more of the safety identifiers. The user, if authorized, may enter additional safety identifiers at step 14.

Other safety-related communications may be retrieved from the memory or entered by a user in step 18. The safety-related communications may include informal communications between supervisor and employee, periodic written bulletins that are distributed to some or all employees, records of accidents or other safety-related incidents and follow-up information, or other safety-related communications.

Safety identifiers may be linked to training programs and other safety-related communications in a database structure. Thus, the system and method can help a user determine structure. Thus, the system and method can help a user determine what training is required for an employee based on the employee's safety identifiers. The system may determine whether an employee received all required actions that are associated with a safety identifier (such as required training sessions or other safety-related communications) in several ways. For example, the system may retrieve employee attendance information 20 from a database via a user input, and/or by a link to a timekeeping system. If the employee was absent during training (step 22), the system may alert 24 the user that the employee missed a required training session. Optionally, the alert may be saved for a later report 34 delivered at the end of the user's session. Training may also be tracked from a database of user input, and if the database indicates that safety training sessions were not completed 26 an alert may be generated 28, either separately or in a final report.

In addition, even if an employee has completed a safety training session, the system may generate an alert 32 if the completed training sessions or the safety identifiers associated with the training sessions have been modified (step 30).

An authorized user may update the training sessions and/or safety identifiers 36 if the user enters an appropriate authorization code 40, such as a password. If the training sessions or safety identifiers have been modified (which may occur, for example, when a new job procedure is implemented or a job function has changed) the system may generate an alert 32, either separately or in the final report 34. The final report may be delivered 34 to the user on a computer screen, in a printout, in an electronic communication as a transmission to a portable or other wired or wireless device, or by any other method.

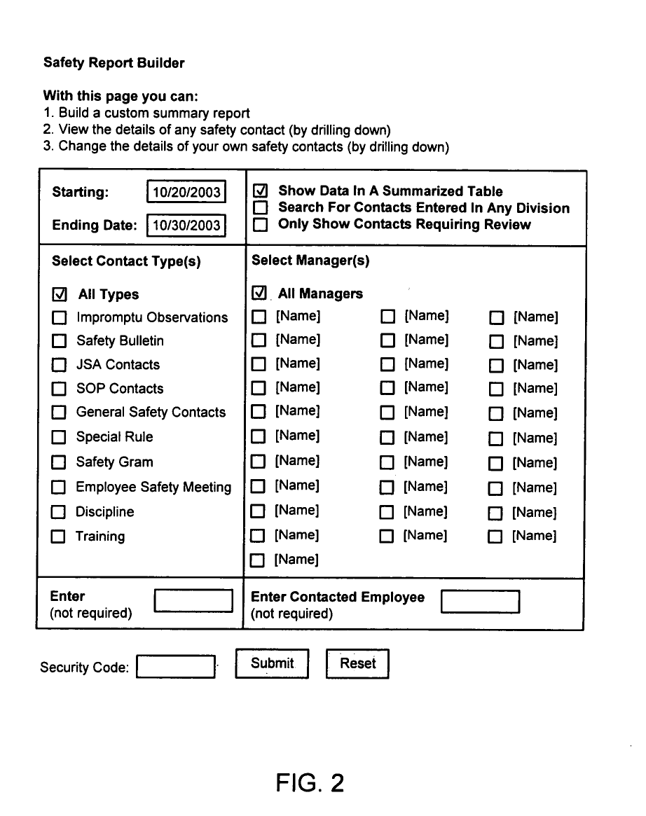

FIG. 2 illustrates an exemplary computer screen where a user, preferably a supervisor, may search for safety-related communications for managers and/or their employees. The employer may select one or more managers or employees, either from a list or by entering an employee identification code (such as a name, employee number, or other identifier). The user may choose to receive all types of communications, or the user may choose only to review specific information such as training sessions relating to standard operating procedures, disciplinary contacts, impromptu observations, or confirmation of receipt of written communications. Preferably, the user must enter a security code before being permitted to see any of this information.

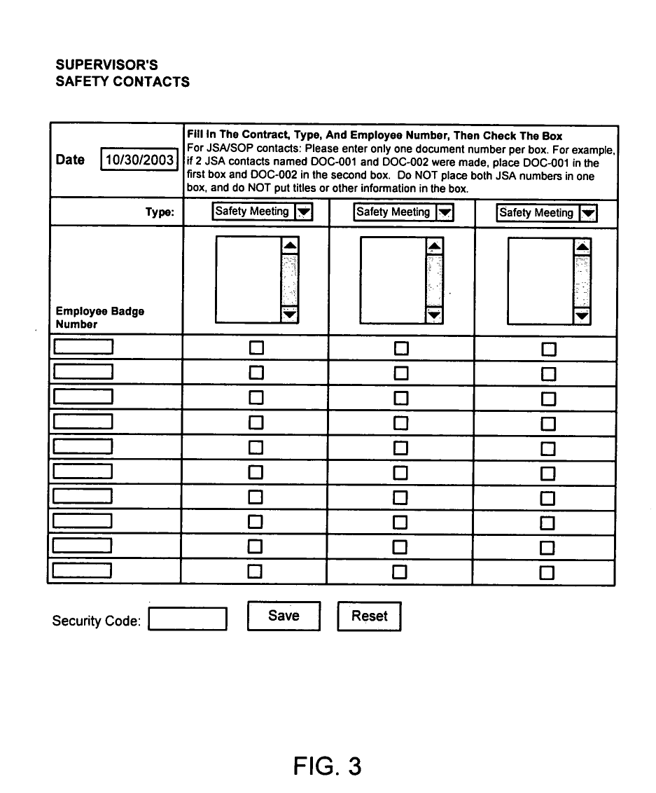

FIG. 3 is an exemplary screen print showing a screen wherein an authorized user can enter safety-related information and communications for individual employees. The employees may be selected by an identification number or other input means. The type of safety-related contact, such as a meeting, written communication, disciplinary action, or other communication may be entered either in a text box and/or selected from a drop down list. Preferably, the user must enter an authorization code before being permitted to add any information to the system.

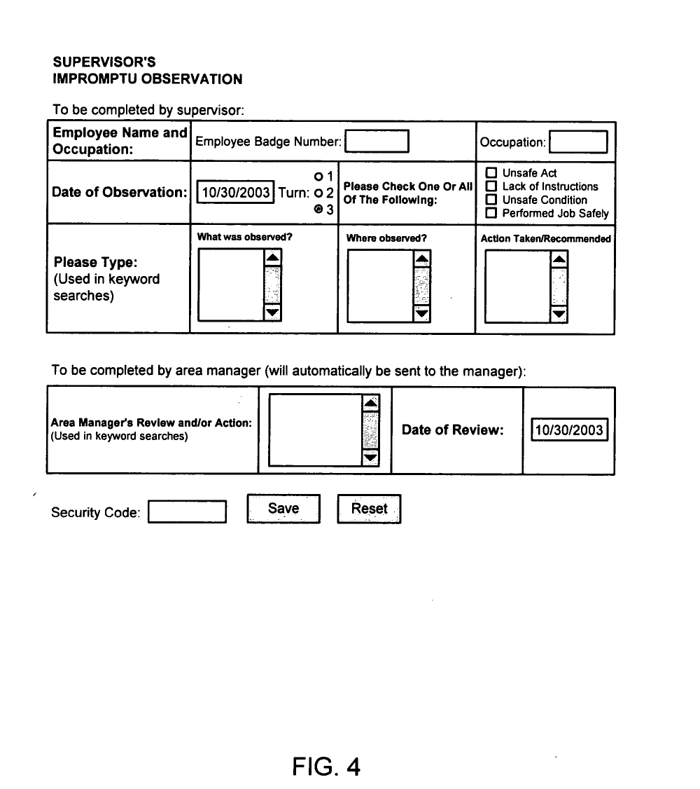

FIG. 4 is a printout of an exemplary screen wherein a user may enter information about impromptu observations of individual employees. For example, a supervisor may enter an identification code for an employee and indicate if and when the employee performed a safe act or an unsafe act. If a particular unsafe condition was observed, or if any other observation was made, the system preferably allows the supervisor to enter narrative comments and recommended actions to be taken. When the supervisor, after entering a security code, saves the information to the system, an alert for follow up action may be automatically sent to the supervisor, the employee and/or another person such as an area manager or human resources director. The follow up alert may be sent by email, interoffice mail, or by another means to ensure that follow up action occurs following an observation.

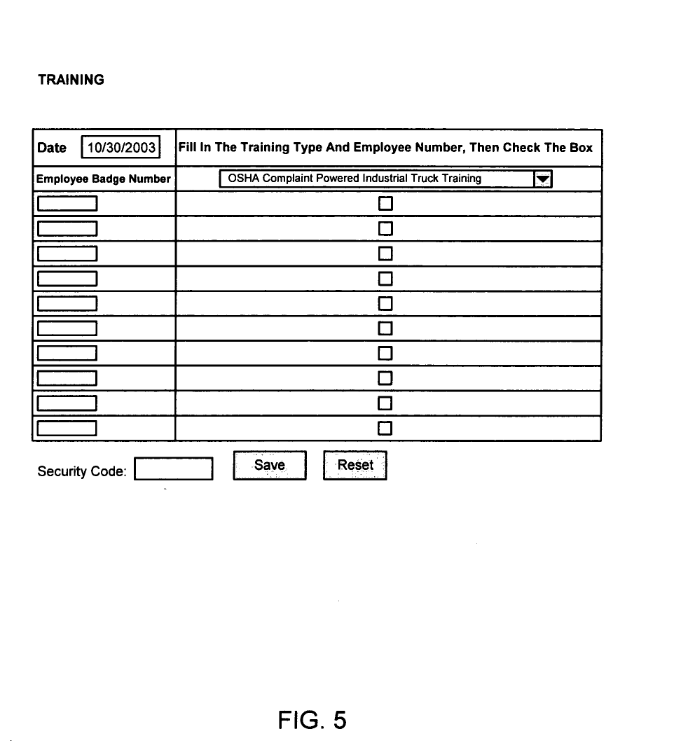

FIG. 5 illustrates an exemplary screen whereby the user may enter information about completed training sessions that an employee has received. This information may be entered, for example, by entering an employee identification number and selecting a training session from the drop down list. Of course, other methods of entering training sessions will be recognized to those skilled in the art. Preferably, the user must enter a security code before entering or saving any information to the system.

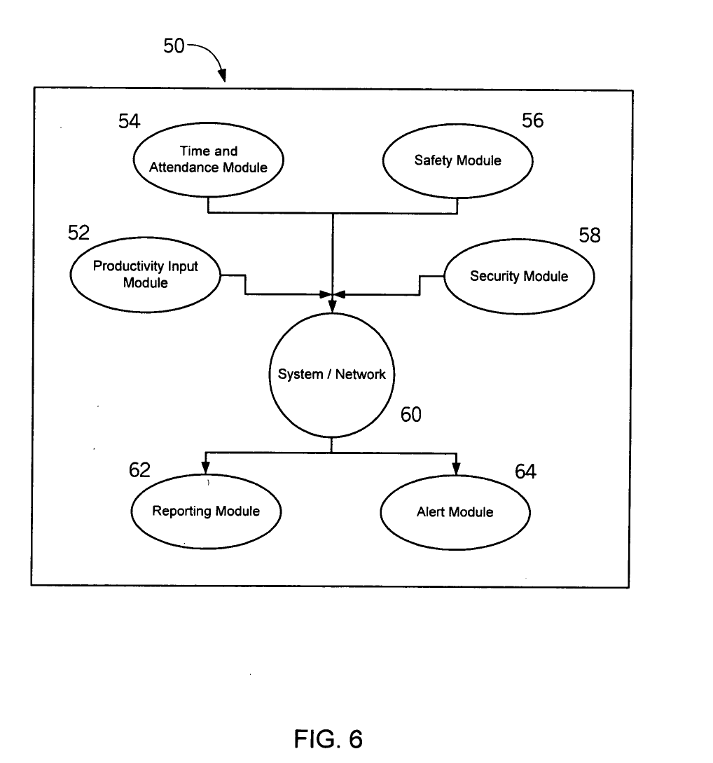

FIG. 6 is a block diagram that illustrates an exemplary system embodiment of the present invention. Referring to FIG. 6, the present inventive system 50 may include a productivity input module 52, a time and attendance input module 54, a safety input module 56 and/or a security input module 58. Other modules may receive information from a user, and may store appropriate information in one or more databases.

The modules may communicate with each other over a communications network 60 such as the Internet, an intranet, or they may be resident on a single server or processing system so that information may be shared among the modules. The system may include a reporting module 62 that provides a user with information based on the information resident in the system. Optionally, an alert module 64 may generate alerts either to the user, or to other users on the network, upon the occurrence of certain conditions, such as described earlier in this document.

The productivity input module 52 may include information taken from shop or assembly line monitors, factory production data, or directly from user input. Optionally, it may include existing software used for monitoring employee productivity. The time and attendance input module 54 may include manually entered or automated information about the days and hours that an employee is present on the job. The safety module 56 may accept information such as that shown and described with reference to FIGS. 2-5 above. The security module 58 may include procedures that require a user to enter an authorization code, such as a password or a biometric identifier, before entering information into the system, or retrieving information from the system. Preferably, the security module 58 periodically “locks down” the system so that unauthorized access is prohibited if a user happens to walk away from a terminal.

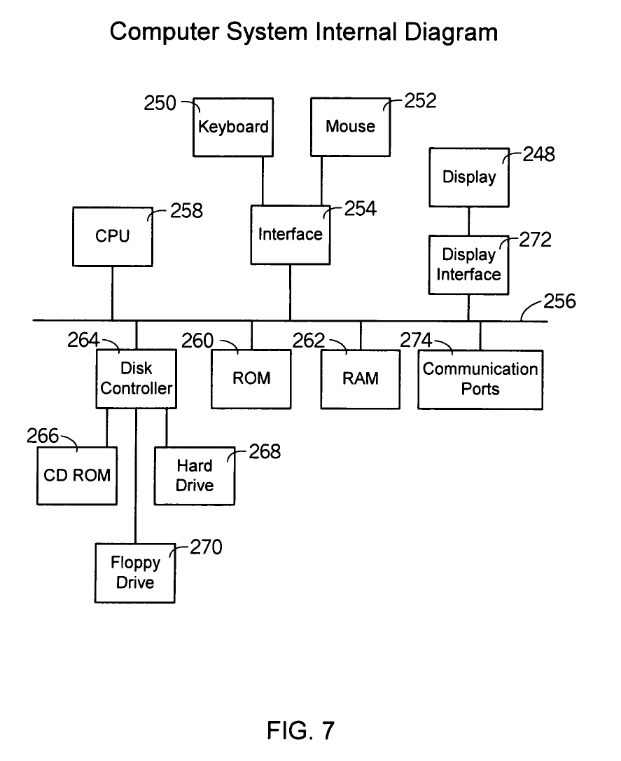

FIG. 7 is a block diagram of exemplary hardware that may be used to contain and/or implement the program instructions of the system and embodiments of the present invention. Referring to FIG. 7, a bus 256 serves as the main information highway interconnecting the other illustrated components of the hardware. CPU 258 is the central processing unit of the system, performing calculations and logic operations required to execute a program. Read only memory (ROM) 260 and random access memory (RAM) 262 constitute memory devices.

A disk controller 204 interfaces one or more optional disk drives to the system bus 228. These disk drives may be external or internal floppy disk drives such as 210, external or internal CD-ROM, CD-R, CD-RW or DVD drives such as 206, or external or internal hard drives 208. As indicated previously, these various disk drives and disk controllers are optional devices.

Program instructions may be stored in the ROM 218 and/or the RAM 220. Optionally, program instructions may be stored on a computer readable carrier such as a floppy disk or a digital disk or other recording medium, a communications signal, or a carrier wave.

Each of the productivity module, the time and attendance input module, the safety module, the security module, the report module and the alert module may be a software application stored in one or more of the disk drives connected to the disk controller 204, the ROM 218 and/or the RAM 220. Preferably, the CPU 202 may access the modules as required.

A display interface 222 may permit information from the bus 228 to be displayed on the display 224 in audio, graphic or alphanumeric format. Communication with external devices may optionally occur using various communication ports such as 226.

In addition to the standard computer-type components, the hardware may also include data input devices such as a keyboard 214 or pointing input devices 216 such as a remote control, pointer, mouse and/or joystick.

Although the invention has been described with reference to the preferred embodiments, it will be apparent to one skilled in the art that variations and modifications are contemplated within the spirit and scope of the invention. The drawings and description of the preferred embodiments are made by way of example rather than to limit the scope of the invention, and it is intended to cover within the spirit and scope of the invention all such changes and modifications.

1. A method of organizing employee safety information, comprising:
maintaining, in a computer-readable medium, a set of safety identifiers, wherein each safety identifier relates to at least one safety-related job procedure, and wherein each safety identifier also corresponds to at least one occupation identifier;
obtaining an employee identifier that corresponds to an employee;
linking the employee identifier with an occupation identifier;
identifying which safety identifiers correspond to the linked occupation identifier to yield the identified safety identifiers that may apply to the employee; and
reporting information corresponding to at least one of the identified safety identifiers.

2. The method of claim 1, wherein each safety identifier in the set corresponds to at least one training session, and wherein the method further comprises:
accessing, from a memory, a set of completed training session identifiers, wherein each completed training session identifier represents a training session that the employee has completed; and
after the identifying step, determining whether any of the identified safety identifiers have corresponding training sessions that are not represented in the set of completed training session identifiers; and
in the reporting step, reporting information corresponding to safety identifiers having corresponding training sessions that are not represented in the set of completed training session identifiers so that a user is informed of the job procedures for which the employee requires additional training.

3. The method of claim 2, wherein each training session comprises an oral safety-related communication to the employee and/or a written safety-related communication to the employee.

4. The method of claim 2:
wherein one or both of the job procedures and the training sessions may be modified; and
wherein the reporting step informs the user of job procedures and/or training sessions that have been modified so that the user is informed of the job procedures for which the employee requires additional training.

5. The method of claim 3 further comprising generating an alert if there is any job procedure for which the employee requires additional training.

6. The method of claim 4 further comprising generating an alert if there is any job procedure for which the employee requires additional training.

7. The method of claim 1, wherein each of the safety identifiers corresponds to at least one training session, and wherein the method further comprises:
receiving time and attendance data for the employee;
determining whether any training session occurred at a time when the employee was not in attendance; and
generating an alert if there are training sessions that occurred at a time when the employee was not in attendance.

8. The method of claim 7, wherein a user must enter a security identifier before time and attendance data will be received for the employee.

9. The method of claim 1, wherein the reporting step includes reporting any job procedures for which the employee has not received required training.

10. The method of claim 1, wherein:
the employee is a supervisory employee; and
the occupation identifier corresponds to an occupation for which the supervisory employee has supervisory responsibility.

11. The method of claim 1, further comprising:
maintaining, in the computer-readable medium, a record of safety-related communications made to the employee;
allowing a user to view the record of safety-related communications; and
allowing the user to modify the record of safety-related communications if the user has entered a security identifier.

12. The method of claim 11 further comprising generating an alert if a safety-related communication in the record corresponds to an unsafe act by the employee.

13. An employee safety reporting system, comprising:
an employer computing system having a memory and a processor;
wherein the memory stores computer program instructions that instruct the employer computing system to perform the steps of:
maintaining, in the memory, a set of safety identifiers, wherein each safety identifier relates to at least one safety-related job procedure, and wherein each safety identifier also corresponds to at least one occupation identifier;
obtaining an employee identifier that corresponds to an employee;
linking the employee identifier with an occupation identifier;
identifying which safety identifiers correspond to the linked occupation identifier to yield the identified safety identifiers that may apply to the employee; and
reporting information corresponding to at least one of the identified safety identifiers.

14. The system of claim 13, wherein the instructions also instruct the employer's computing system to perform the steps of:
accessing, from a memory, a set of completed training session identifiers, wherein each completed training session identifier represents a training session that the employee has completed; and
after the identifying step, determining whether any of the identified safety identifiers have corresponding training sessions that are not represented in the set of completed training session identifiers; and
in the reporting step, reporting information corresponding to safety identifiers having corresponding training sessions that are not represented in the set of completed training session identifiers so that a user is informed of the job procedures for which the employee requires additional training.

15. An employee timekeeping system, comprising:
an employer computing system having a memory and a processor, wherein the memory includes data corresponding to safety-related training sessions and times at which the training sessions were delivered, wherein each training session is linked to at least one occupation code;
an input module that accepts employee identifiers and employee time and attendance data, wherein each employee identifier corresponds to an individual employee; and
a safety reporting module that:
links the employee identifier for an individual employee to an occupation code to yield a linked occupation code;
identifies the training sessions that correspond to the linked occupation code;
based on the employee time and attendance data for an individual employee, determines whether the individual employee was present at the time when a training session that corresponds to the linked occupation code was delivered; and
generates an alert if the individual employee was not present at a time when the training session that corresponds to the linked occupation code was delivered.

16. An employee productivity monitoring system, comprising:
a computing apparatus having a memory and a processor;
a productivity input module that accepts measurements of productivity from a production environment; and
a time and attendance input module that accepts employee identifiers, occupation codes and employee time and attendance data, wherein each employee identifier corresponds to an individual employee;
wherein the memory includes a set of occupation codes that are linked to the production environment;
wherein the processor is programmed to determine, based on the occupation codes and the time and attendance data received via the input module, which measurements of productivity correspond to an individual employee; and
wherein the system further includes a reporting module that generates reports of the measurements of productivity that correspond to the individual employee.

17. The system of claim 16 further comprising:
a security module that prevents the input module from accepting employee time and attendance data unless a security identifier is first accepted.

18. The system of claim 16 wherein the memory also includes a set of safety procedure identifiers, each safety procedure identifier corresponds to at least one occupation identifier, and the system also comprises:
a safety training module that based on at least one occupation code entered for an employee, identifies which safety procedure identifiers correspond to the entered occupation code to yield the safety procedure identifiers that apply to the employee; and
wherein the reporting module also generates reports of the safety procedure identifiers that apply to the employee.

19. The system of claim 18 further comprising an alert module that generates an alert if there is any safety procedure for which the individual employee requires additional training.
